(19) United States
(12) Patent Application Publication
(10) Pub. No.: US 2024/0343151 A1
(43) Pub. Date: Oct. 17, 2024

(54) ADAPTATION OF ELECTRIC VEHICLE CHARGING COMMUNICATION PARAMETERS

(71) Applicant: GM GLOBAL TECHNOLOGY OPERATIONS LLC, Detroit, MI (US)

(72) Inventors: Nikhil A. Kale, Novi, MI (US); Sandeep U. Menon, Troy, MI (US); Bridget A. Beaton, Novi, MI (US)

(73) Assignee: GM GLOBAL TECHNOLOGY OPERATIONS LLC, Detroit, MI (US)

(21) Appl. No.: 18/299,350

(22) Filed: Apr. 12, 2023

(51) Int. Cl. B60L 53/66; B60L 53/62; B60L 58/16

(52) U.S. Cl. CPC B60L 53/66; B60L 53/62; B60L 58/16; B60L 2240/545; B60L 2240/66; B60L 2240/70

(57) ABSTRACT

A system and method for adaptation of electric vehicle charging communication parameters that includes commencing, by an electric vehicle (EV), a communication session between the EV and an electric vehicle supply equipment (EVSE) charging station. The communication session includes extracting a vehicle charging communication session parameter from the EVSE charging station and validating, by the EV, that the vehicle charging communication session parameter with a default charging parameter. A direct current or an alternating current charging of the EV, based on a digital communication parameter received by the EVSE charging station, is initiated. In the event of a failure of the communication session, the vehicle charging communication session parameter is relaxed and a restarted EV charging session is initiated, where if the restarted EV charging session is successful, a deviation parameter is generated.

### INTRODUCTION

Vehicles are rapidly integrating ever increasing technological components into their systems, especially in the direction of hybrid electric and battery based electric vehicles (EVs). EVs are becoming increasingly popular as an environmentally friendly alternative to traditional gasoline-powered vehicles. However, one of the challenges associated with EVs is the need for efficient and convenient charging infrastructure configured to support multiple types and styles of EVs.

While existing charging stations are not readily available in all locations, those that do exist may operate using a variety of charging criteria and parameters. Although attempts have been made to develop standards for the charging of EVs, those standards may be implemented by different electric vehicle supply equipment (EVSE) operators in different ways leading to issues in compatibility, charging times, and failures to complete a charging session with an EV.

For example, one set of EVSE charging stations may support the use of credit or debit cards, while others may only support a smartphone network application or a radio frequency identification device. Therefore, if a driver pulls into a charging station, attempting to pay for a charging session using a credit or debit card, which requires the use of encrypted communications with a credit/debit processing system, only to find out that the charging station is not configured to execute encrypted communications, the result may be disappointing. In addition, the vehicle may not have enough charge to reach another charging station.

### SUMMARY

Disclosed herein are a system and method for adaptation of electric vehicle charging communication parameters. While a number of standards have been agreed upon by various EVSE operators, there is also a variety of interpretations of those standards. For example, charging system standards specified in DIN 70121/ISO 15118-20 state that a charging station should take no longer than 7 seconds to reach the voltage requested by the EV and complete a pre-charge sequence. However, a vehicle may be able to tolerate a more relaxed standard, for example 7.2 seconds and still complete a successful charging session. Therefore, the vehicle timeout may be adjusted beyond 7 seconds to prioritize customer availability, but potentially put vehicles permanently out of conformance with the standard.

Thus, a system for adaptation of electric vehicle charging communication parameters may include an electric vehicle (EV) including a communication module that may commence a communication session between the EV and an electric vehicle supply equipment (EVSE) charging station at an initiation of an EV charging session. The communication module may also extract a vehicle charging communication session parameter from the EVSE charging station during the communication session and validate the vehicle charging communication session parameter with a default charging parameter. However, if there is a failure of the communication session during the EV charging session occurs a relaxed charging parameter based on an adaptation of the vehicle charging communication session parameter may be used for a restarted EV charging session. In addition, if a communication session of the restarted EV charging session is successful a deviation parameter may be generated.

Another aspect of the disclosure may include a server, wherein if the failure of the communication session occurs the communication module may transmit the deviation parameter to the server.

Another aspect of the disclosure may include if the failure of the EV charging session occurs the communication module may transmit, to the server, a vehicle environmental parameter.

Another aspect of the disclosure may include that the vehicle environmental parameter may include one or more of a global positioning system coordinate, a diagnostic trouble code, a vehicle plugin status, and a battery parameter.

Another aspect of the disclosure may include the EVSE charging station which may charge the EV using a direct current or an alternating current based on a digital communication parameter received by the EVSE charging station during the communication session.

Another aspect of the disclosure may include that the relaxed charging parameter may include a predefined maximum possible deviation.

Another aspect of the disclosure may include that the EV may monitor a variability of the vehicle charging communication session parameter.

Another aspect of the disclosure may include the vehicle charging communication session parameter which may include one or more of a communication timeout, a retry count, a startup/initialization delay, a charge threshold, an optional charge parameter, or a payment option.

Another aspect of the disclosure may include a database configured to store the deviation parameter and a vehicle environmental parameter.

Another aspect of the disclosure may include a method for adaptation of electric vehicle charging communication parameters that may include commencing, by an electric vehicle (EV), a communication session between the EV and an electric vehicle supply equipment (EVSE) charging station at an initiation of an EV charging session. The method may further include extracting, during the communication session, a vehicle charging communication session parameter from the EVSE charging station. The method may continue by validating, by the EV, the vehicle charging communication session parameter with a default charging parameter. Further, the method may include starting a direct current or an alternating current, charging of the EV based on a digital communication parameter received by the EVSE charging station during the communication session. Then, the method may include relaxing, if a failure of the communication session occurs, the vehicle charging communication session parameter based on an adaptation of the vehicle charging communication session parameter and also initiating a restarted EV charging session. The method may conclude by generating, if a communication session of the restarted EV charging session is successful, a deviation parameter.

Another aspect of the method may include the default charging parameter may be for a particular EVSE charging station.

Another aspect of the method may include transmitting the deviation parameter to a server.

Another aspect of the method may include transmitting a vehicle environmental parameter to a server.

Another aspect of the method may include that the vehicle environmental parameter includes one or more of a global positioning system coordinate, a diagnostic trouble code, a vehicle plugin status, and a battery parameter.

Another aspect of the method may include relaxing the vehicle charging communication session parameter with the use of a predefined maximum possible deviation.

Another aspect of the method may include monitoring a variability of the vehicle charging communication session parameter.

Another aspect of the method may include that the vehicle charging communication session parameter includes one or more of a communication timeout, a retry count, a startup/initialization delay, or a charge threshold.

Another aspect of the method may include registering the deviation parameter in a database.

Another aspect of the method may include monitoring a variability of the vehicle charging communication session parameter after the relaxing of the vehicle charging communication session parameter.

Another aspect of the disclosure may include a method for adaptation of electric vehicle charging communication including commencing, by an electric vehicle (EV), a communication session between the EV and an electric vehicle supply equipment (EVSE) charging station at an initiation of an EV charging session. The method may include extracting, during the communication session, a vehicle charging communication session parameter from the EVSE charging station and validating, by the EV, the vehicle charging communication session parameter with a default charging parameter. The method may further include starting a direct current, or an alternating current, charging of the EV based on a digital communication parameter received by the EVSE charging station during the communication session and relaxing, if a failure of the communication session occurs, the vehicle charging communication session parameter based on an adaptation of the vehicle charging communication session parameter. The method may then include initiating a restarted EV charging session and generating, if a communication session of the restarted EV charging session is successful, a deviation parameter, transmitting the deviation parameter to a server, and transmitting a vehicle environmental parameter to the server, where the environmental parameter includes at least one of a temperature, an age of a battery, a type of a battery pack or power electronics, or a time of day. The method may also include monitoring a variability of the adaptation of the vehicle charging communication session parameter, registering the deviation parameter in a database, and monitoring the variability of the vehicle charging communication session parameter after the relaxing of the vehicle charging communication session parameter.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of an electric vehicle (EV) and an electric vehicle supply equipment (EVSE) charging station at an initiation of an EV charging session, in accordance with the disclosure.

FIG. 2 is an illustration of a mobility operator in control of a set of EVSE charging stations designed to service a set of EVs, in accordance with the disclosure.

FIG. 3 is an illustration of a single set of EVSE charging stations in conjunction with a database for delivery of EVSE charging sessions, in accordance with the disclosure.

FIG. 4 is a flowchart of an EVSE charging session with adaptation of charging communication parameters, in accordance with the disclosure.

FIG. 5 is a flowchart of a method for adaptation of electric vehicle charging communication parameters, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

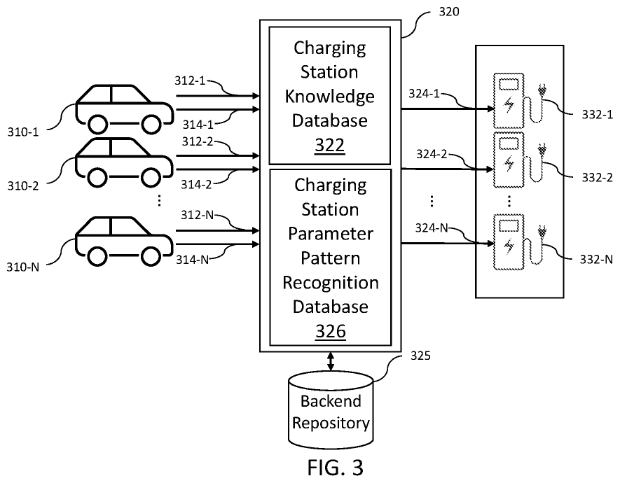

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

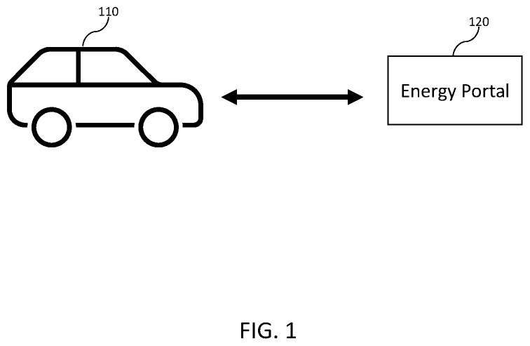

FIG. 1 illustrates a charging system 100 for an electric vehicle 110 and an energy portal 120, according to an embodiment of the present disclosure. Electric vehicle 110 may be charged in multiple ways. For example, energy portal 120 may contain a standard 120-volt household electrical outlet that may be used to provide a slow form of charging, typically overnight. In another embodiment, electric vehicle 110 may connect to the energy portal 120 that includes a higher-voltage-240 volt-dedicated charging station that may be installed at a home or in a public location, for example a parking garage or shopping center, to provide a somewhat quicker charge than the 120-volt system. Energy portal 120 may also include a fast-charging station that utilizes a high-capacity direct current approach. Fast-charging stations may typically be found at public charging stations, highway rest stops, and other locations accessed by long-distance travelers.

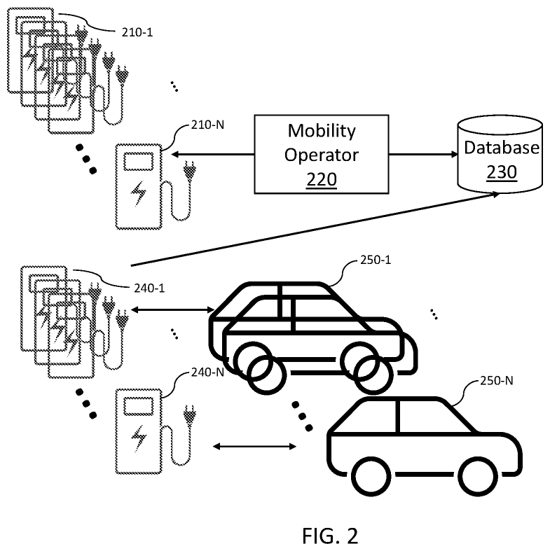

This disclosure will focus on intelligent fast charging energy portals. FIG. 2 is an illustration of a charging system 200 that includes a mobility operator 220 that administers sets of EVSE charging stations 210-1 through 210-N, according to an embodiment of the present disclosure. The mobility operator 220 may also maintain a database 230 that may contain information related to the EVSE charging stations 210-1 through 210-N that are under its control. Charging system 200 also illustrates one set of EVSE charging stations 240-1 through 240-N under the control of mobility operator 220 that may be used by vehicles 250-1 through 250-N.

Database 230 may be used to store information relating to the charging stations under the control of mobility operator 220, e.g., EVSE charging stations 210-1 through 210-N and EVSE charging stations 240-1 through 240-N. Such information may include an identification number or code of each charging station including a Media Access Control (MAC) address. The information may also include global positioning system (GPS) coordinates of each charging station. The information may also include a history of usage of the charging station such as prior startups and shutdowns of a charging session. It may also include a log of prior faults or failure charge events. The information may also include some of the charging station's energy capabilities such as its power, voltage, and current ratings. The information may also include the type of services supported, for example the ability to use RFID cards or a credit/debit card, or even a membership card. The information may also include the charging station's current health and timestamp metrics, for example the charging station has been operational for the last number of hours, days, or months—or that the last failure or fault occurred at a particular date and time. The information may also include a set of charging station characteristics or parameters such as its timing delays or communication handshakes and protocols supported.

The vehicles 250-1 through 250-N may also be associated with various sets of vehicle parameters, for example vehicle environmental parameters and vehicle charge communications session parameters, which may also be communicated and/or stored back to database 230. The vehicle environmental parameters may include information such as the GPS coordinates of the vehicle, multiple diagnostic trouble code statuses, and a state of health and associated timestamps of the vehicle. The vehicle environmental parameters may also include a vehicle plugin status, e.g., is the vehicle plugged into an EVSE charging station. The information may also include environmental data such as ambient temperature, a temperature of the batteries, parameters concerning the batteries such as voltage or other battery parameters. The information may also include data related to the vehicle's energy needs, settings, or schedule. The information may also include planned route or trip information including stored points of interest or stopovers.

Vehicle charge communication session parameters may include those parameters and information associated with pertinent communication parameters between the EV and the EVSE that are needed to initiate and maintain a charging session. For example, vehicle charge communication session parameters may include allowable times to initiate and maintain a communication link including allowable performance times. Additional parameters may include minimum or maximum thresholds and charging parameters. Parameters may also include optional signals or data received from the EVSE. In the event of a communication failure the EV may receive or determine failure causes or codes and appropriate response codes. The parameters may include an identification code from the EVSE including or in addition to a MAC address of the EVSE. The parameters may also include some type of charge authentication, for example an external identification means for a “plug and charge,” also referred to as PnC. The parameters may also include additional service details.

In addition, database 230 may also collect parameters and other information associated with a vehicle charging session with vehicles 250-1 through 250-N where such charging session data may be stored by a vehicle, including deviations made during a session. Vehicle charging station information may include data such as dynamic adaptations encountered during a charging session including communication timeouts, retry counts, startup, or initialization delay. Other charging session information may include optional and mandatory parameter handlings algorithms or charge parameters or thresholds. The vehicle charging session information may be stored in the vehicle and/or communicated back to a database, for example, database 230.

FIG. 3 is an illustration of an EVSE charging scenario 300 with a charging station database, according to an embodiment of the present disclosure. As mentioned above in FIG. 2, an EV may be associated with its set of vehicle environmental parameters and vehicle charge communication session parameters. Also, as mentioned in FIG. 2, during an EV charging session additional information regarding a particular charging session with a particular EVSE charging station may be captured and stored by the vehicle and subsequently stored in a database, for example in database 230. The EVSE charging scenario 300 illustrates the ability to combine acknowledged vehicle parameters and EVSE charging station parameters and charging characteristics for a particular EVSE charging station. Thus, database 320 may collect vehicle charge communication session parameters 312-1 and vehicle environmental parameters 314-1 for the vehicle 310-1. And, consequently, database 320 may also collect vehicle charge communication session parameters 312-2 and vehicle environmental parameters 314-2 for the vehicle 310-2, and so on through vehicle charge communication session parameters 312-N and vehicle environmental parameters 314-N for the vehicle 310-N.

Database 320 may also store the vehicle charging station information collected during a charging session including one or more dynamic adaptations that were encountered. This information may be used to construct a charging station knowledge database 322. In addition, the data within the charging station knowledge database 322 may be analyzed to detect patterns. Thus, the charging station parameter pattern recognition database 326 may also be able to predict optimized communication parameters for future charging sessions or for additional charging stations. For example, if a certain parameter is detected to be out of a particular tolerance about a threshold amount for a particular mobility operator, the charging station parameter pattern recognition database 326 may discern that the same parameter has a high probability of being out of tolerance for another charging station operated by the same mobility operator.

Accordingly, for example, when vehicle 310-1 connects with EVSE 332-1 for a charging session, data, or dynamic adaptation design elements, for example, adaptation elements 324-1 may be forwarded to EVSE 332-1 for a charging session with vehicle 310-1, where the adaptation design elements relate to vehicle 310-1 and EVSE 332-1. In a similar fashion, if vehicle 310-1 connects with EVSE 332-2, then adaptation design elements related to vehicle 310-1 and EVSE 332-2 may be used for that particular vehicle charging session. Further, any combination of adaption elements 324-1, 324-2 through 324-N may be associated with EVSE 332-1, 332-2, through 332-N. Thus, database 320 may be used to optimize charging communication parameters between vehicles 310-1, 310-2 through vehicle 310-N in combination with EVSE 332-1, EVSE 332-2 through EVSE 332-N in multiple possible configurations and combinations. Furthermore, a particular charging station deviations and associated adaptations may be deployed to multiple vehicles, not just one particular vehicle.

Further, a backend repository 325 may be associated with a backend system for use with a business-to-business channel or repository. The backend repository 325 may also be used for data collection, data analysis, and data correlation.

Data collection may include identifying defined design patterns that may have contributed to a failure. For example, collected data may include EVSE charging communication failure events with associated timestamps and response codes. The collected data may also include functions and parameters that may have contributed to a failure including data correlation with diagnostic trouble codes, such as if there were internal or external faults observed that may have resulted in an event. Such data may also include data relevant to identifying a root cause of a failure, for example, a timing parameter, charge parameter, or option signal that may be unique to EVSE authorization and service.

Data analysis may include generic pattern recognition with respect to events. For example, the analysis may include a sequence of time stamped events relative to an EVSE charging session. The analysis may also be based on an active handling, versus a post event analysis, of potential charging communication events. The analysis may also be used to identify issues within a fleet operation for fleet monitoring versus a vehicle specific monitoring. Analysis may also include analysis of environmental conditions such as temperatures and voltages.

Data correlation may include fleet monitoring and analysis such as common behavior observed with respect to a specific version of software for a charging communication session. The correlation may also include monitoring of events to determine if a variation is part of a pattern or an expected event.

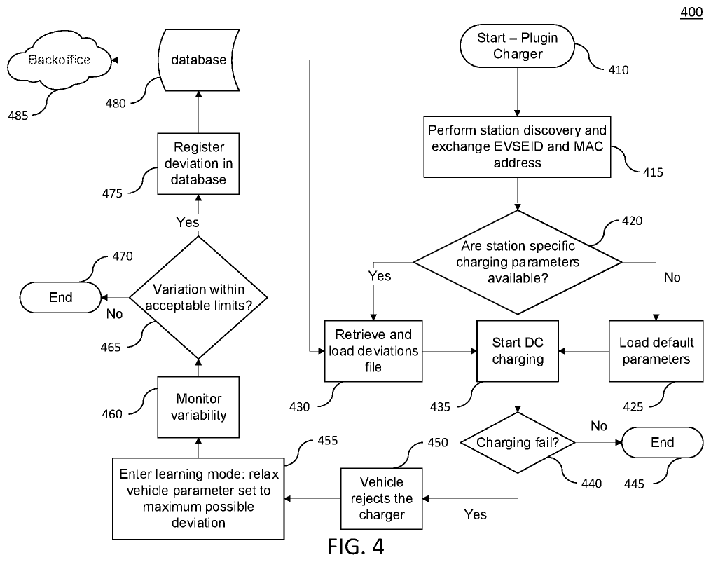

FIG. 4 is a flowchart 400 of an EVSE charging session with an EV, according to an embodiment of the present disclosure. Flowchart 400 may be directed to three general areas. The first is learning communication charging parameters while charging an EV. This area may include identifying deviations in the charging process and overriding communication parameters that may be specified in proposed or adopted standards. Such an approach may be used to ensure successful charging and discharging of EV batteries to enhance a driver's experience while attempting to comply with applicable standards.

The second area is that of dynamically adapting communication charging parameters to EVSE charging stations of different manufacturers. Identifying and learning the characteristics of a charging session may allow a vehicle to dynamically accommodate different station manufacturers in real time and minimize validation and vehicle development efforts. Such learning may also decrease field issues due to interoperability, especially issues determined after production of a charging station due to charging dropout events.

The third area may include pattern recognition and correlation to enhance a user's charging experience. In an embodiment a customer profile for a particular vehicle may be built based on that vehicle's charging pattern and experience. That profile may also be sent to a back-office database infrastructure to analyze patterns, correlate to different datasets, for example, charger manufacturer, fleet ownership, geographic location, etc. In addition, a charging station profile database may be deployed back to other vehicles to improve a charging experience.

Flowchart 400 may begin at step 410 with a plugging in of a charger cord from the EVSE charging system to the EV. On connecting the charger, the EV will first establish a communications session with the charger. At step 415 the charging station and EV may perform a discovery period where the charging station may provide an EVSE identification number or a MAC address. Step 415 may also include a validation process, where on connecting the charger, the EV may establish communications with the EVSE charging station. This may include where the EV validates communication parameters against an expected set of communication parameters, for example, a threshold number of allowed communication timeouts. As discussed, an expected set of communication parameters may include parameters that are consistent with a set of standards, for example the charging system standards specified in DIN 70121/ISO 15118-20.

At step 420 a determination may be made if station specific charging parameters are available. If specific charging parameters are not available, then at step 425 a set of default parameters are loaded. Default parameters may be based on charging standards and may include an expected set of communication parameters, for example, communication timeouts. However, if station specific charging parameters are available, then at step 430, a deviations file may be retrieved and loaded. The deviations file may include allowable deviation amounts from a set of default parameters based on a profile for the specific charger. The deviations file may exist on the charging station knowledge database 322 and accessed through a cloud-based connection. The charging station knowledge database 322 may be capable of preparing the EV settings or configuration to a pre-determined set of variances prior to the actual charging session.

At step 435, based on either the loaded default parameters or the loaded deviations file the charging of the EV may commence. In an embodiment the charging may be done using direct current (DC) or in another embodiment, based on the EV and charging stations parameters, the charging may be done using alternating current (AC).

At step 440 the charging process may continue and if there are no disruptions or failures, then the charging may continue to completion and the process may end at step 445. However, if the charging process encounters a failure, then at step 450 the vehicle may reject the charging session process due to the failure.

At step 455 the vehicle may enter a learning mode to determine if a relaxing of a charging communication session parameter may overcome the failure. For example, as discussed above, the DIN/ISO charging system standards specify a 7 second threshold for the EVSE charging station to reach the voltage requested by the EV. However, if the 7 second threshold parameter may be relaxed to, for example, 7.5 seconds and the actual time to reach the required voltage is 7.2 seconds, then the “deviation” of 0.2 seconds may be recorded for that specific EVSE charging station.

In a similar fashion, other EVSE charging station parameters may also be relaxed, for example, parameters that may include a communication timeout, a retry count, a startup/initialization delay, a charge threshold, a payment option, or an optional charging parameter.

At step 460 the variability of one or more of the vehicle charging communication session parameters may continue to be monitored, where if another failure occurs the learning mode of step 455 may be repeated with an additional vehicle charging parameter being relaxed to overcome the additional failure if possible.

The learning mode at step 455 may include learning additional communication parameters during the charging process. The learning may include identifying deviation and overriding communication parameters specified in one or more standards. The overriding may be done to ensure successful charging and discharging of high voltage EV batteries to enhance a customer's experience but yet maintain compliance with standards.

In an embodiment, in the event of a communication failure, the EV, either on a next plug cycle or with a possible user intervention, may enter the learning mode at step 455. In the learning mode the EV may relax its timing parameters to accommodate the encountered variation and finalize a maximum likelihood threshold. In the learning mode, for receive parameters, the EVSE charger may calculate the difference between the expected and the actual difference for each of a violated event and may assign a maximum likelihood variance to the expected value. If the variance is within an acceptable range, in step 465, the variance data may be programmed in memory against a particular EVSE charging station. This may be done such that the next time the same charger is connected to an EV, for example identified via an EVES/ID or MAC address, the maximum likelihood variance may be applied to determine a new range of parameters. In addition, the newly learned parameters may then be transferred to database 480 or backoffice 485 to create an EVSE charging system profile.

The learning process may also be directed to allow an EV to dynamically adapt and accommodate different charging station manufacturers thereby minimizing validation and vehicle development effort. The learning process may also decrease field issues due to interoperability. The learning process may also include analysis of the learned data through pattern recognition and correlation. In an embodiment, an intelligence may be built locally in the vehicle for a customer profile based on a charging pattern.

At step 465 the deviations of one or more parameters may be checked to determine if the deviation is within predefined acceptable limits. For example, the above example of the 7 second threshold to reach the voltage requested by the EV may include an acceptable limit of 7.5 seconds where in the example the EVSE charging station reached the required voltage within 7.2 seconds and therefore within the acceptable limit. In that situation, the variation would be within the acceptable limit and would proceed to step 475. If the variation, or deviation, was not within the acceptable limit then the process would end at step 470.

At step 475 the deviation may be registered in a database. The deviation may also include other information associated with the EVSE charging station or the EV itself. For example, the information may include GPS coordinates of the EVSE charging station, an EVSE identification number or MAC address, a listing of services supported by the EVSE charging station, and timestamped metrics or status of the EVSE charging station. In addition, information about the mobility operator associated with the EVSE charging station may also be stored.

Further, the information may also include data associated with the EV, such as a global positioning system coordinate, a diagnostic trouble code, a vehicle plugin status, and a battery parameter. The information may also include environmental parameters, for example, a temperature, an age of a battery, a type of a battery pack or power electronics, or a time of day.

The database 480 may include an in-vehicle database, or profile. The database may also be sent and stored to a backoffice 485 configuration. Further, the database information may also be sent back to step 430 as a load deviations file for a specific EVSE charging station. Database 480 or the backoffice 485 may also be shared via a communications infrastructure for analysis, correlations, and deployment to other vehicles.

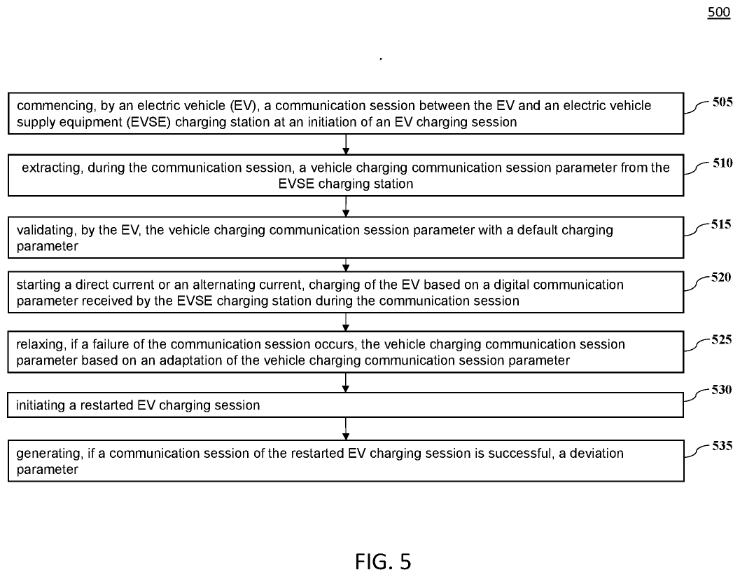

FIG. 5 shows an exemplary embodiment of a method 500 for adaptation of electric vehicle charging communication parameters, according to an embodiment of the present disclosure. Method 500 begins at step 505 by commencing, by an electric vehicle (EV), a communication session between the EV and an electric vehicle supply equipment (EVSE) charging station at an initiation of an EV charging session. An EV charging session with an EVSE charging station is initiated by establishing a communication session between the charging station and the vehicle, prior to the start of charging as information between the EVSE charging station and the EV would first be established.

As discussed in FIG. 2, EVSE charging stations may be under the control of a mobility operator, where that mobility operator may configure its EVSE charging stations to communicate with an EV during a charging session based on certain standards. The communication session between the EV and the EVSE charging stations may include the exchange of multiple types of information regarding the vehicle, the charging station capabilities, and a method of payment.

For example, information may also include a history of usage of the charging station such as prior startup and shutdown of a charging session. It may also include a log of prior faults or failure charge events. The information may also include some of the charging station's energy capabilities such as its power, voltage, and current ratings. The information may also include the type of services supported, for example the ability to use RFID cards or a credit/debit card, or even a membership card. The information may also include the charging station's current health and timestamp metrics, for example the charging station has been operational for the last number of hours, days, or months—or that the last failure or fault occurred at a particular date and time. The information may also include a set of charging station characteristics or parameters such as its timing delays or communication handshakes and protocols supported.

At step 510, an extracting, during the communication session, of a vehicle charging communication session parameter from the EVSE charging station is performed. As discussed in FIG. 4, a vehicle charging communication session parameters may include a communication timeout, a retry count, a startup/initialization delay, a charge threshold, a payment option, or an optional charging parameter.

At step 515 the method includes validating, by the EV, the vehicle charging communication session parameter with a default charging parameter. As discussed in FIG. 4, the default charging parameter may include parameters that are consistent with the charging system standards specified in DIN 70121/ISO 15118-20. As discussed, vehicle charging communication session parameters may include a communication timeout value, a retry count, a startup/initialization delay, a charge threshold, an optional charge parameter, or a payment option. Validating the charging parameters is directed to ensuring that the communication parameters are within an acceptable range prior to starting an actual transfer of energy from the EVSE charging station to the EV.

At step 520, upon a successful validation, the method may include starting a direct current or an alternating current, charging of the EV based on a digital communication parameter received by the EVSE charging station during the communication session. EVs may typically be charged using a high-capacity direct current but may also be charged using alternating current. Thus, during the communication session, for example in step 510, one of the vehicle charging communication session parameters may include the type of charging current to be used.

Step 525 may include relaxing, if a failure of the communication session occurs, the vehicle charging communication session parameter based on an adaptation of the vehicle charging communication session parameter. As discussed in FIG. 4, a vehicle may reject the charger due to a communication session failure, for example the scenario where the expected charging communication session parameter included a 7 second threshold for the charging station to reach the voltage requested by the EV. In that example since the charging station failed to reach the requested voltage the charging session may be aborted. To overcome the failure, a relaxing of a charging communication session parameter may be accomplished. Thus, at step 530, upon initiating another plug cycle, or with a possible user intervention, a restarted EV charging session may be initiated. In the restarted EV charging session, the relaxed parameter may be utilized. Thus, in the 7 second parameter example above, that parameter may be revised to 7.5 seconds.

Then, in step 535, the method may include generating, if a communication session of the restarted EV charging session is successful, a deviation parameter. In the 7 second example, the deviation parameter may be 0.2 seconds if the charging station reaches the voltage requested by the EV in 7.2 seconds. The deviation parameter applies to the specific charging station but may also be indicative of other charging stations controlled by the same mobility operator. Method 500 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A system for adaptation of electric vehicle charging communication parameters comprising:
an electric vehicle (EV) comprising a communication module configured to commence a communication session between the EV and an electric vehicle supply equipment (EVSE) charging station at an initiation of an EV charging session;
the communication module further configured to extract a vehicle charging communication session parameter from the EVSE charging station during the communication session;
the EV configured to validate the vehicle charging communication session parameter with a default charging parameter;
wherein if a failure of the communication session during the EV charging session occurs a relaxed charging parameter based on an adaptation of the vehicle charging communication session parameter is used for a restarted EV charging session; and
wherein if a communication session of the restarted EV charging session is successful a deviation parameter is generated.

2. The system of claim 1, further comprising a server, wherein if the failure of the communication session occurs the communication module is further configured to transmit the deviation parameter to the server.

3. The system of claim 2, wherein if the failure of the EV charging session occurs the communication module is further configured to transmit, to the server, a vehicle environmental parameter.

4. The system of claim 3, wherein the vehicle environmental parameter comprises one or more of a global positioning system coordinate, a diagnostic trouble code, a vehicle plugin status, and a battery parameter.

5. The system of claim 1, wherein the EVSE charging station is configured to charge using a direct current or an alternating current based on a digital communication parameter received by the EVSE charging station during the communication session.

6. The system of claim 1, wherein the relaxed charging parameter comprises a predefined maximum possible deviation.

7. The system of claim 1, wherein the EV is further configured to monitor a variability of the vehicle charging communication session parameter.

8. The system of claim 1, wherein the vehicle charging communication session parameter comprises one or more of a communication timeout, a retry count, a startup/initialization delay, a charge threshold, an optional charge parameter, or a payment option.

9. The system of claim 1, further comprising a database configured to store the deviation parameter and a vehicle environmental parameter.

10. A method for adaptation of electric vehicle charging communication parameters comprising:
commencing, by an electric vehicle (EV), a communication session between the EV and an electric vehicle supply equipment (EVSE) charging station at an initiation of an EV charging session;
extracting, during the communication session, a vehicle charging communication session parameter from the EVSE charging station;
validating, by the EV, the vehicle charging communication session parameter with a default charging parameter;
starting a direct current or an alternating current, charging of the EV based on a digital communication parameter received by the EVSE charging station during the communication session;
relaxing, if a failure of the communication session occurs, the vehicle charging communication session parameter based on an adaptation of the vehicle charging communication session parameter;
initiating a restarted EV charging session; and
generating, if a communication session of the restarted EV charging session is successful, a deviation parameter.

11. The method of claim 10, wherein the default charging parameter is for a particular EVSE charging station.

12. The method of claim 10, further comprising transmitting the deviation parameter to a server.

13. The method of claim 10, further comprising transmitting a vehicle environmental parameter to a server.

14. The method of claim 13, wherein the vehicle environmental parameter comprises one or more of a global positioning system coordinate, a diagnostic trouble code, a vehicle plugin status, and a battery parameter.

15. The method of claim 10, wherein the relaxing the vehicle charging communication session parameter comprises use of a predefined maximum possible deviation.

16. The method of claim 10, further comprising monitoring a variability of the vehicle charging communication session parameter.

17. The method of claim 10, wherein the vehicle charging communication session parameter comprises one or more of a communication timeout, a retry count, a startup/initialization delay, or a charge threshold.

18. The method of claim 10, further comprising registering the deviation parameter in a database.

19. The method of claim 10, further comprising monitoring a variability of the vehicle charging communication session parameter after the relaxing of the vehicle charging communication session parameter.

20. A method for adaptation of electric vehicle charging communication comprising:
commencing, by an electric vehicle (EV), a communication session between the EV and an electric vehicle supply equipment (EVSE) charging station at an initiation of an EV charging session;
extracting, during the communication session, a vehicle charging communication session parameter from the EVSE charging station;
validating, by the EV, the vehicle charging communication session parameter with a default charging parameter;
starting a direct current or an alternating current, charging of the EV based on a digital communication parameter received by the EVSE charging station during the communication session;
relaxing, if a failure of the communication session occurs, the vehicle charging communication session parameter based on an adaptation of the vehicle charging communication session parameter;
initiating a restarted EV charging session;
generating, if a communication session of the restarted EV charging session is successful, a deviation parameter;
transmitting the deviation parameter to a server;
transmitting a vehicle environmental parameter to the server, wherein the environmental parameter comprises at least one of a temperature, an age of a battery, a type of a battery pack or power electronics, or a time of day;
monitoring a variability of the adaptation of the vehicle charging communication session parameter;
registering the deviation parameter in a database; and
monitoring the variability of the vehicle charging communication session parameter after the relaxing of the vehicle charging communication session parameter.
